(19) United States
(12) Patent Application Publication
(10) Pub. No.: US 2022/0188957 A1
(43) Pub. Date: Jun. 16, 2022

(54) SYSTEM AND METHOD FOR BLOCKING A RIDE-HAILING ORDER

(71) Applicant: BEIJING DIDI INFINITY TECHNOLOGY AND DEVELOPMENT CO., LTD., Beijing (CN)

(72) Inventors: Conghui Fu, Sunnyvale, CA (US); Wei Wang, Sunnyvale, CA (US); Kaidan Yang, Beijing (CN); Zhendong Li, Burlingame, CA (US); Yifang Yuan, Beijing (CN); Xin Chen, Sunnyvale, CA (US)

(73) Assignee: BEIJING DIDI INFINITY TECHNOLOGY AND DEVELOPMENT CO., LTD., Beijing (CN)

(21) Appl. No.: 17/123,102

(22) Filed: Dec. 15, 2020

(51) Int. Cl. G06Q 50/30; G06Q 30/02; G06Q 50/26

(52) U.S. Cl. CPC G06Q 50/30; G06Q 50/265; G06Q 30/0205

(57) ABSTRACT

Embodiments of the disclosure provide systems and methods for blocking a ride-hailing order. The method may include receiving incident data associated with a plurality of incidents. The incident data indicates a time and a location of each incident. The method may also include determining, by a processor, an area encompassing the locations of the plurality of incidents. The method may further include determining, by the processor, a plurality of time intervals each encompassing the time of at least one incident. The method may further include determining, by the processor, a time slot by merging the plurality of time intervals based on a time gap between every two neighboring time intervals. The method may further include designating, by the processor, a combination of the area and the time slot as a block zone and blocking an order generated from the area during the time slot of the block zone.

### TECHNICAL FIELD

The present disclosure relates to the field of ride hailing service, and more particularly relates to driver safety control by blocking potentially dangerous orders.

### BACKGROUND

Taxis service plays a vital role in modern urban life. Ride hailing service becomes a new model of taxi service and makes ride service more affordable, more environment friendly and more convenient. Especially with the use of Global Positioning System (GPS), part-time drivers who are not familiar with the area where they are driving around can also provide a ride service delivering the passengers to their destination. However, crimes also increase with the rise of this industry. Many ride hailing drivers provide the ride hailing service part-time and they are not familiar with all the areas where they are heading to pick up a passenger. Therefore, it is difficult for the drivers to tell whether the order initiates from a dangerous area upon receiving an order to pick up a passenger.

In order to alert the drivers, ride hailing service platforms may collect incident data reported by drivers, such as a robbery by the passenger. Sometimes the incident data also comes from official authority, such as a release from the relevant branch of the government. With the incident data collected, a pattern of incidents can be observed, and dangerous areas and time slots may be predicted. Based on the prediction, the drivers may be alerted ahead of time.

However, the existing methods determining what area or what time period as a dangerous zone are suboptimal. For one thing, the incident data can be dynamic and change over time. Especially when a potential perpetrator finds that it becomes difficult to place an order in a marked dangerous zone, the potential perpetrator may move to another area to place another order, which is likely to be a neighboring area of the previous determined dangerous zone. For another thing, even in a certain dangerous area, the incidents may only occur during limited time slots. For instance, in the neighborhood of a night club, the time period when incidents occur frequently may be limited to the nighttime, and in the daytime at the same neighborhood it can be safe for drivers to receive an order and pick up a passenger. Therefore, if an area is blocked as dangerous for the whole day without differentiating the specific dangerous time slots from the safe time slots, the marked dangerous zone can be overly broad.

The disclosed system and method provide an improved driver safety control by blocking potentially dangerous orders.

### SUMMARY

Embodiments of the disclosure provide a method for blocking a ride-hailing order. The exemplary method includes receiving incident data associated with a plurality of incidents. The incident data indicates a time and a location of each incident. The exemplary method further includes determining, by a processor, an area encompassing the locations of the plurality of incidents. The exemplary method also includes determining, by the processor, a plurality of time intervals each encompassing the time of at least one incident. The exemplary method also includes determining, by the processor, a time slot by merging the plurality of time intervals based on a time gap between every two neighboring time intervals. The exemplary method also includes designating, by the processor, a combination of the area and the time slot as a block zone. The exemplary method additionally includes blocking an order generated from the area during the time slot of the block zone.

Embodiments of the disclosure also provide a system for blocking a ride-hailing order. The exemplary system includes a storage device configured to store incident data associated with a plurality of incidents. The incident data indicates a time and a location of each incident. The exemplary system further includes a processor, configured to determine an area encompassing the locations of the plurality of incidents; determine a plurality of time intervals each encompassing the time of at least one incident; determine a time slot by merging the plurality of time intervals based on a time gap between every two neighboring time intervals; designate a combination of the area and the time slot as a block zone; and block an order generated from the area during the time slot of the block zone.

Embodiments of the disclosure also provide a non-transitory tangible computer-readable medium storing instructions. The instructions, when executed by a processor, perform a method for blocking a ride-hailing order. The exemplary method includes receiving incident data associated with a plurality of incidents. The incident data indicates a time and a location of each incident. The exemplary method also includes determining an area encompassing the locations of the plurality of incidents. The exemplary method further includes determining a plurality of time intervals each encompassing the time of at least one incident. The exemplary method further includes determining a time slot by merging the plurality of time intervals based on a time gap between every two neighboring time intervals. The exemplary method further includes designating a combination of the area and the time slot as a block zone. The exemplary method additionally includes blocking an order generated from the area during the time slot of the block zone.

It is to be understood that both the foregoing general description and the following detailed description are exemplary and explanatory only and are not restrictive of the invention, as claimed.

### BRIEF DESCRIPTION OF THE DRAWINGS

FIG. 1 illustrates a block diagram of an exemplary system for blocking a ride-hailing order, according to embodiments of the disclosure.

FIG. 2 illustrates a schematic diagram of an exemplary map showing incidents marked on it, according to embodiments of the disclosure.

FIG. 3 illustrates a flow chart of an exemplary method for blocking a ride-hailing order, according to embodiments of the disclosure.

FIG. 4 illustrates a flow chart of an exemplary method for designating a block zone, according to embodiments of the disclosure.

FIG. 5 illustrates another flow chart of an exemplary method for designating a block zone, according to embodiments of the disclosure.

FIG. 6 illustrates a flow chart of an exemplary method for designating a block zone with expanded area, according to embodiments of the disclosure.

FIG. 7 illustrates exemplary incident data collected for a geohash region, according to embodiments of the disclosure.

FIG. 8 illustrates exemplary time slots determined by merging time intervals of collected incident data, according to embodiments of the disclosure.

FIG. 9 illustrates exemplary time slots with incident count determined based on collected incident data, according to embodiments of the disclosure.

FIG. 10 illustrates an exemplary incident rate calculated based on collected incident data, according to embodiments of the disclosure.

FIG. 11 illustrates a schematic diagram of an exemplary expanded area, according to embodiments of the disclosure.

### DETAILED DESCRIPTION

Reference will now be made in detail to the exemplary embodiments, examples of which are illustrated in the accompanying drawings. Wherever possible, the same reference numbers will be used throughout the drawings to refer to the same or like parts.

Embodiments of the present disclosure provide systems and methods for blocking a ride-hailing order generated from an area during a time slot. In some embodiments, the system may be implemented as part of an online ride-hailing service platform (e.g., DiDi™ online), where a driver provides transportation service to a passenger using a service vehicle. The online ride hailing service platform can receive an online service request from a user (e.g., a passenger) and then route the service request to at least one service provider (e.g., a taxi driver, a private car owner, or the like) to fulfill the service request. The service request can be answered by a service provider, or be assigned to a service provider if no one picks up the service request within a predetermined time period. The service provider and the passenger may each communicate via an application installed on a terminal device. In such a context, the terminal device may be a mobile phone, a wearable device, a PDA, etc. used by the driver (“a driver device”) or the passenger (“a passenger device”).

For example, the system for blocking a ride-hailing order generated from an area during a time slot may include a storage device configured to store incident data associated with a plurality of incidents and a processor configured to designate a combination of an area and a time slot as a block zone based on the incident data and block an order generated from the block zone. In some embodiments, the processor may also be configured to determine an area encompassing the locations of the plurality of incidents, determine a plurality of time intervals each encompassing the time of at least one incident, determine a time slot by merging the plurality of time intervals based on a time gap between every two neighboring time intervals, and designate a combination of the area and the time slot as the block zone. In some embodiments, the processor may be configured to merge two time intervals when the time gap between them is below a time threshold.

In some embodiments, the processor may be configured to designate a combination of the area and the time slot as the block zone when the incident number or the incident rate exceeds a rate threshold. In some embodiments, the processor may also be configured to expand the area to be designated as the block zone if the incident data in the expanded area exceeds an expanded rate threshold. In some embodiments, the incident data is updated periodically and the system is configured to update the block zone based on the updated incident data.

Consistent with the present disclosure, an “incident” may be a crime committed by a passenger who requested the ride-hailing service. For example, a perpetrator may order a ride-hailing service and then commit theft or robbery when the driver arrives or after the driver picks the perpetrator up. It is contemplated that an incident could also be a non-crime event that nevertheless harms the driver, his property, or his ability to provide raid-hailing service. For example, a perpetrator may allure a driver to a rural area and then cancel the order, which wastes the driver's time and increase his gas expense. There can be a pattern of where and when an incident is more likely to happen. The incident can be reported by the driver victim to the ride-hailing service platform or to the police, and incident data is generated containing the time and location of the occurrence of the incident.

By blocking orders from a designated area during a designated time slot, the system and method protect ride-hailing drivers from potential incidents and at the same time does not over-block orders not from the dangerous block zone.

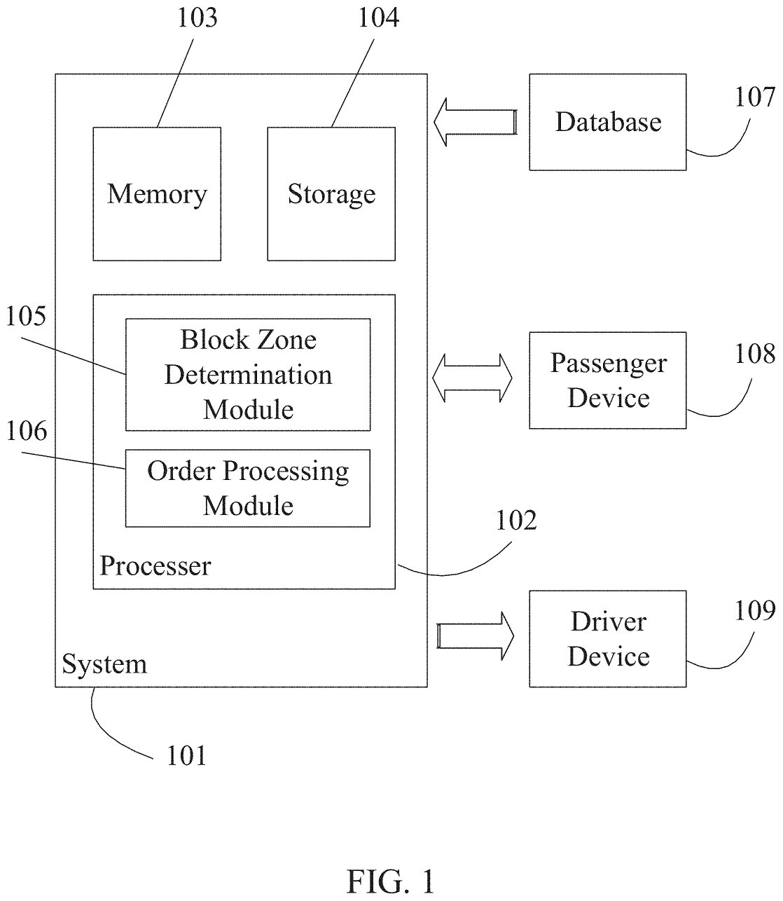

For example, FIG. 1 illustrates a block diagram of an exemplary system 101 for blocking a ride-hailing order, according to embodiments of the disclosure. In some embodiments, system 101 may include at least one processor, such as processor 102, at least one memory, such as memory 103 and at least one storage, such as storage 104. Processor 102 may include several modules, such as a block zone determination module 105 and an order processing module 106. The system 101 may have interactions with a database 107, a passenger device 108 and a driver device 109. In some embodiments, system 101 may have different modules in a single device, such as an integrated circuit (IC) chip (e.g., implemented as an application-specific integrated circuit (ASIC) or a field-programmable gate array (FPGA)), or separate devices with dedicated functions. In some embodiments, one or more components of system 101 may be located in a cloud computing environment or may be alternatively in a single location (such as inside a mobile device) or distributed locations. Components of system 101 may be in an integrated device or distributed at different locations but communicate with each other through a network (not shown).

Processor 102 may include any appropriate type of general-purpose or special-purpose microprocessor, digital signal processor, or microcontroller. Processor 102 may be configured as a separate processor module dedicated to analyzing incident data received from database 107, receiving service request from passenger device 108, and routing the request to driver device 109. Alternatively, processor 102 may be configured as a shared processor module for performing other functions unrelated to service request processing. Processor 102 may include one or more hardware units (e.g., portion(s) of an integrated circuit) designed for use with other components or to execute part of a program. The program may be stored on a computer-readable medium, and when executed by processor 102, it may perform one or more functions.

Memory 103 and storage 104 may include any appropriate type of mass storage provided to store any type of information that processor 102 may need to operate. Memory 103 and storage 104 may be a volatile or non-volatile, magnetic, semiconductor-based, tape-based, optical, removable, non-removable, or other type of storage device or tangible (i.e., non-transitory) computer-readable medium including, but not limited to, a ROM, a flash memory, a dynamic RAM, and a static RAM. Memory 103 and/or storage 104 may be configured to store one or more computer programs that may be executed by processor 102 to perform functions disclosed herein. For example, memory 103 and/or storage 104 may be configured to store program(s) that may be executed by processor 102 to designate a combination of an area and a time slot as a block zone and block an order generated from the area during the time slot of the block zone. Memory 103 and/or storage 104 may be further configured to store information and data used by processor 102. For instance, memory 103 and/or storage 104 may be configured to store the incident data received from database 107.

Block zone determination module 105 and order processing module 106 (and any corresponding sub-modules or sub-units) can be hardware units (e.g., portions of an integrated circuit) of processor 102 designed for use with other components or software units implemented by processor 102 through executing at least part of a program. The program may be stored on a computer-readable medium, such as memory 103 or storage 104, and when executed by processor 102, it may perform one or more functions. Although FIG. 1 shows block zone determination module 105 and order processing module 106 both within one processor 102, it is contemplated that these modules may be distributed among different processors located closely or remotely with each other.

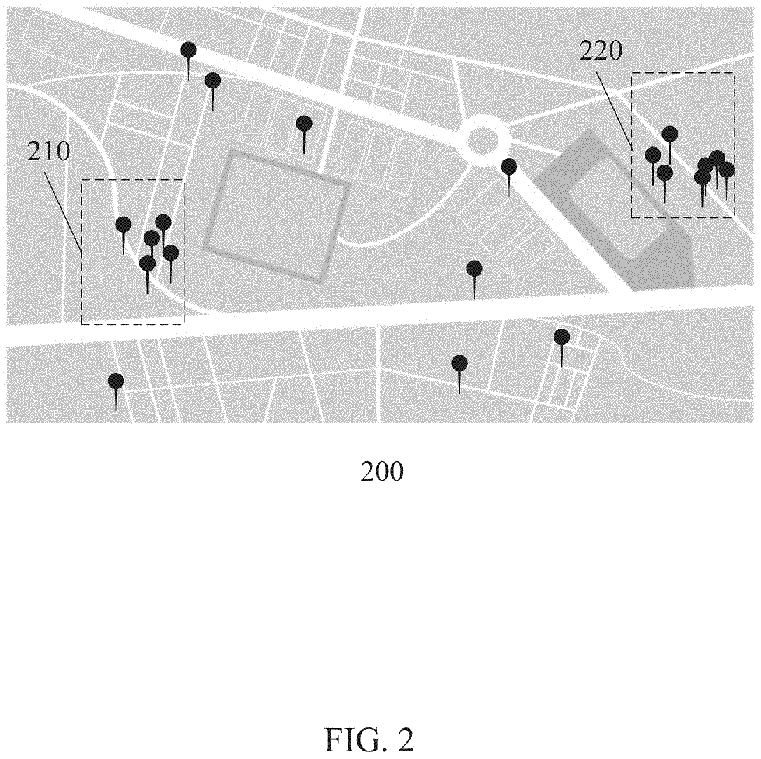

FIG. 2 illustrates a schematic diagram of an exemplary map 200 showing incidents marked on it, according to embodiments of the disclosure. As shown in FIG. 2, certain areas, e.g., areas 210 and 220, may associate with more incidents than other areas. For example, area 210 may be close to a major road thus more passengers may make ride requests from that area. Accordingly, incidents may occur more frequently in area 210. As shown, five incidents occur in area 210 during the relevant monitoring period. As another example, area 220 may be close to a shopping plaza that hosts several restaurants and bars where passengers tend to call a ride service after consumption of alcohol. As shown, seven incidents may occur in area 220 during the relevant monitoring period. The areas where more incidents occur may be deemed as important areas to be further processed by system 101. Other areas in map 200 have sporadic incidents and thus may not be highlighted for further processing.

In some embodiments, incidents may occur more frequently in certain time slots than others. For example, most of the incidents in area 210 may occur during daytime especially the 6:00-9:00 am and 4:00-7:00 pm periods when people commute to or from work. As another example, incidents occurring in area 220 may cluster during the 7:00-11:00 pm period when people leave from the restaurants or bars. The time slots where more incidents occur may also be flagged to be further processed by system 101. The incident data may be stored in database 107. As discussed, the incident data may include the time information and area information of the incidents.

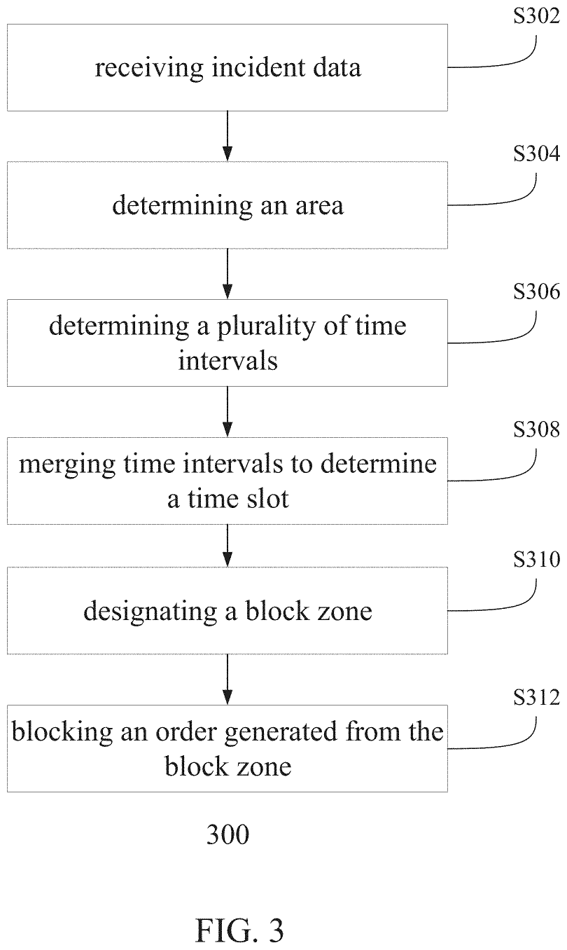

FIG. 3 illustrates a flow chart of an exemplary method 300 for blocking a ride-hailing order, according to embodiments of the disclosure. Method 300 may be implemented by system 101 and may include steps 302-312 as described below. It is to be appreciated that some of the steps may be optional to perform the disclosure provided herein. Further, some of the steps may be performed simultaneously, or in a different order than shown in FIG. 3.

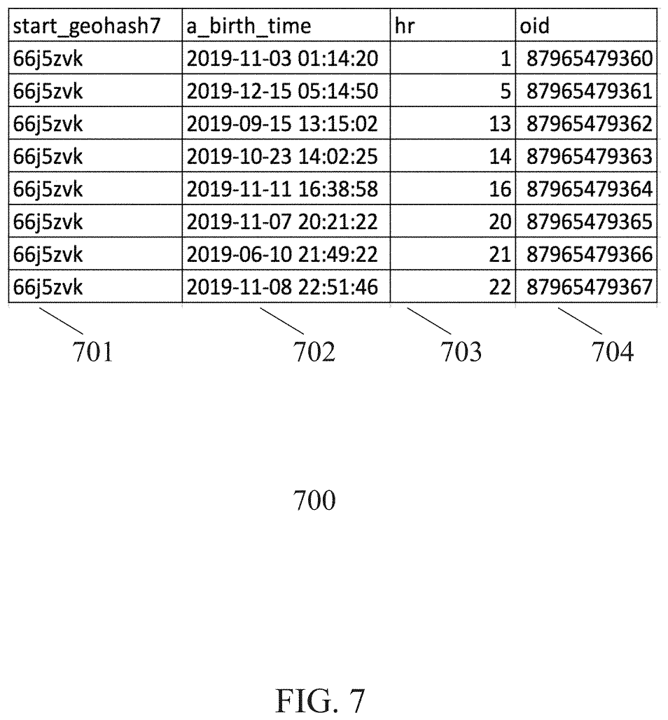

In step S302, database 107 is configured to provide incident data to system 101, and processor 102 is configured to receive the incident data. In some embodiments, the incident data may include the time and location of each incident. For example, FIG. 7 illustrates exemplary incident data collected for a geohash region, according to embodiments of the disclosure. A “geohash region” is a region defined by a geohash system. Geohash is a public domain geocode system. It is a hierarchical spatial data structure which subdivides space into buckets of grid shape. A geohash can be coded using an alphanumeric string that defines a variably sized area with longitude and latitude information. In the hierarchical structure, high precision geohashes have a long string length and represent cells that cover only a small area, and conversely, low precision geohashes have a short string length and represent cells that each cover a large area. For example, a geohash6 can be coded with 6 bits and a geohash7 can be coded with 7 bits. The geohash6 can cover a cell of 1.2 km×609.4 m at the equator while the geohash7 can cover a cell of 152.9 m×152.4 m at the equator. Accordingly, a low precision geohash (e.g., geohash6) can be further partitioned into multiple higher precision geohashes (e.g., geohash7), and a higher precision geohash (e.g., geohash7) may be expanded into a low precision geohash (e.g., geohash6) by merging with neighboring geohashes of the same hierarchy.

In datasheet 700 of FIG. 7, incident data contains four categories of information presented in the four columns, respectively. From left to right, the first column, column 701, represents the geohash region in which each incident occurs. For example, the geohash region listed in column 701 is “66j5zvk,” a geohash7. The second column, column 702, represents the time that each incident happened (the “birth time” of the incident). In the exemplary incident data sheet 700, a 24-hour time system is used. For example, the first incident happened at 01:14:20 and the second incident happened at 05:14:50. In some embodiments, the incident time may be the time the incident was reported rather than the exact time the incident happened. The third column, column 703, represents the time interval the incident happened. In the exemplary incident data sheet 700, the 24-hour period is divided into 24 intervals and the hour number is used to represent the corresponding one-hour time interval. For example, the incident that happened at 01:14:20 is considered to happen during the time interval of “1”, and the incident that happened at 13:15:20 is considered to happen during the time interval of “13”. The fourth column, column 704, is an order ID allocated by the system for every incident.

In some embodiments, block zone determination module 105 is configured to implement steps S304 to S310. In step S304, block zone determination module 105 is configured to determine an area within which at least one incident happened. In some embodiments, the area may be a geohash region as illustrated in FIGS. 7-10. For example, the incident data received from step S302 suggests that at least one incident happened in geohash region “66j5zvk,” then this geohash region is determined as the area in step S304.

In step S306, block zone determination module 105 is configured to determine a plurality of time intervals within each time interval at least one incident happened within the area determined in step S304. For example, as illustrated in FIG. 7, a time interval is set as one hour, and the hour number of the 24-hour time system is set to represent the time interval. In some embodiments, the time interval number only represents the hour when the incidents happened without regard to the date of the incident. For example, an incident that happened at 01:14:20 on Nov. 13, 2019 and another incident that happened at 13:15:01 on Sep. 15, 2019, will be both designated the time interval “1”, notwithstanding they happened on different dates.

In step S308, block zone determination module 105 is further configured to merge neighboring time intervals determined in step S306 into a time slot. In some embodiments, the incident data of an area determined in step S304 may be listed according to their time interval numbers in an ascending or descending order. In some embodiments, when two neighboring time intervals have a time gap of no more than a time threshold (e.g., two hours), the two time intervals can be merged as one time slot. Alternatively, if a time interval determined in step S306 and its neighboring time intervals have a time gap of more than the time threshold (e.g., two hours), then the time interval alone is determined as a time slot by block zone determination module 105.

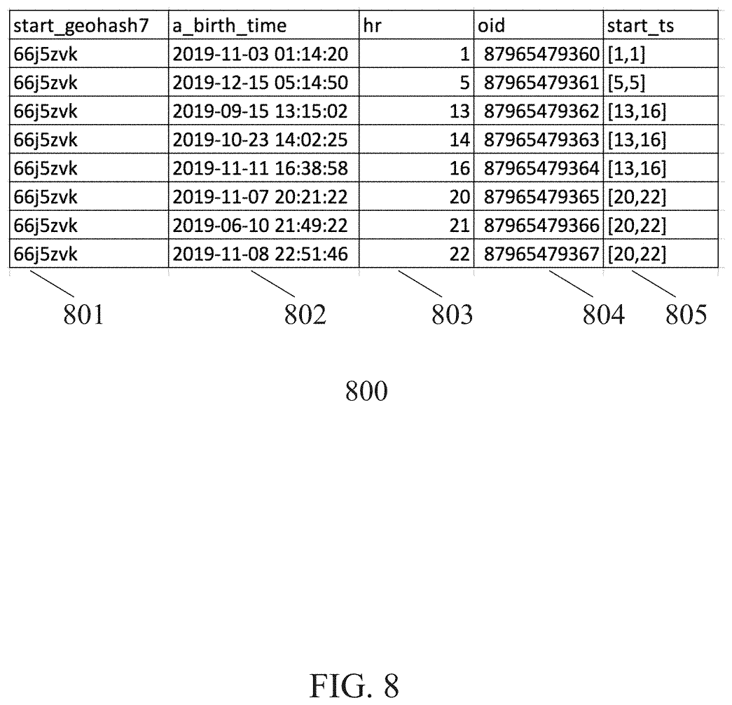

For example, FIG. 8 illustrates exemplary time slots determined by merging time intervals of collected incident data, according to embodiments of the disclosure. Datasheet 800 of FIG. 8 shows data presented in five columns. From left to right, the first four columns 801, 802, 803 and 804 are the same as columns 701, 702, 703, 704 of datasheet 700, while the fifth column, column 805, is added to show the determined time slots. As illustrated by datasheet 800, in some embodiments, when two neighboring time intervals have a time gap of no more than two hours, the two time intervals are merged into one time slot. For example, the time intervals “13”, “14” and “16” have time gaps of no more than two hours, thus they are merged into one time slot [13, 16]. In some embodiments, if a time interval and its neighboring time intervals have a time gap more than two hours, then the time interval alone is determined as a time slot by the block zone determination module 105. For example, the time interval “5” has neighboring time intervals “1” and “13”, and the respective time gaps between the time interval “5” and its neighboring time intervals are both more than two hours, therefore the time interval “5” is not merged with neighboring time intervals and is designated as a time slot [5, 5] by itself.

In step S310, block zone determination module 105 is configured to determine a combination of the area determined in step S304 and a time slot as a block zone. In some embodiments, block zone determine module 105 may select the time slot from those determined in step S308 and determine if it meets certain predetermined criteria.

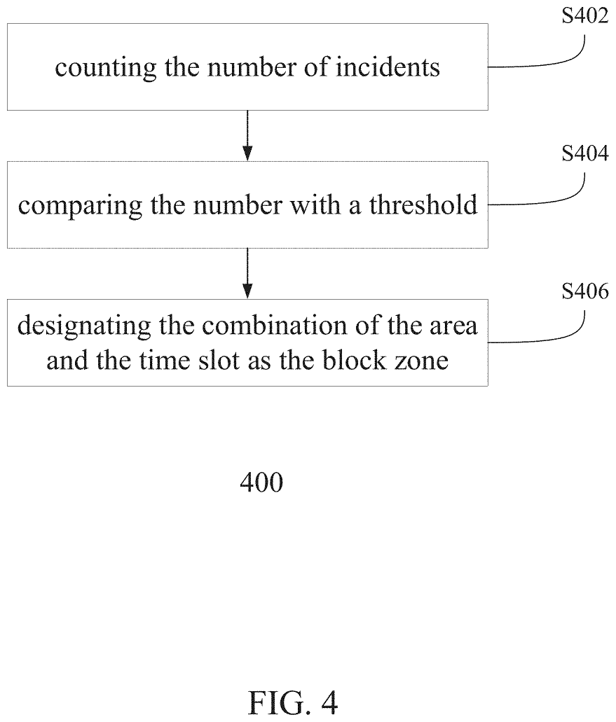

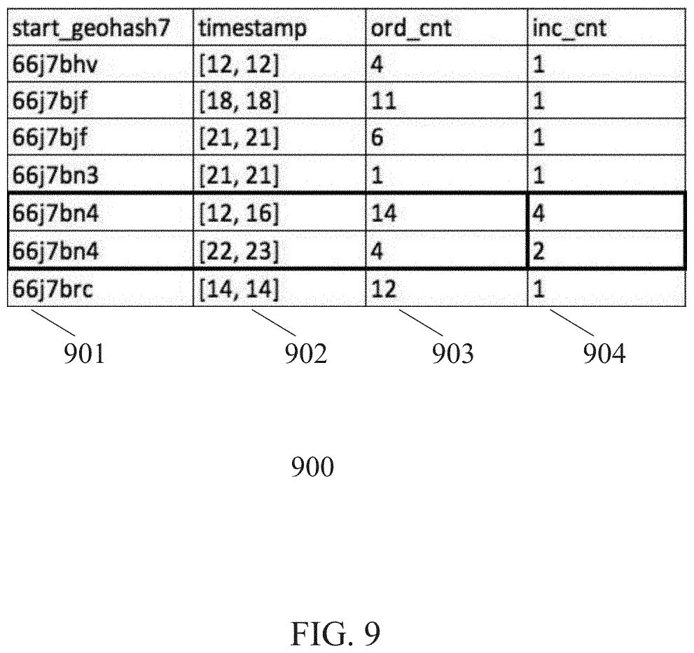

In some embodiments, the block zone may be determined based on the number of incidents in the time slot. For example, FIG. 4 illustrates a flow chart of an exemplary method 400 for designating a block zone, according to embodiments of the disclosure. Method 400 may be implemented by system 101 and may include steps S402-406 as described below. It is to be appreciated that some of the steps may be optional to perform the disclosure provided herein. Further, some of the steps may be performed simultaneously, or in a different order than shown in FIG. 4. FIG. 9 illustrates exemplary time slots with incident count determined based on collected incident data, according to embodiments of the disclosure. FIG. 4 and FIG. 9 will be described together.

In some embodiments, in step S402, block zone determination module 105 is configured to count the number of incidents of the area during the time slot. As illustrated in FIG. 9, in datasheet 900, from left to right, the first column, column 901, lists the geohash regions in which one or more incidents occurred. For example, column 901 lists five different geohash7 regions: “66j7bhv,” “66j7bjf,” “66j7bn3,” “66j7bn4,” and “66j7brc.” The second column, column 902, shows the time slots within which the incidents happened within the respective geohash regions. The third column, column 903, lists the total order count during the time slot within each geohash region. The total order count represents the total number of ride-hailing service orders made from the geohash region during the time slot. The fourth column, column 904, lists the incident count during the time slot within the geohash region. The incident count represents the total number of incidents that occurred the geohash region during the time slot.

In step S404, block zone determination module 105 is further configured to compare the number of incidents with an incident threshold. The incident threshold can be predetermined as a matter of experience, or can be adjusted according to specific situation of each area. For example, if incidents from an area are mostly serious crimes, such as armed robbery causing physical injury of the drivers, the incident threshold in that area should be set lower than an area with most incidents being petty theft. By adjusting the incident threshold, the system can exercise differential control among different areas to block potentially dangerous orders.

In step S406, if the number of incidents is no less than the threshold, block zone determination module 105 is configured to designate the combination of the area and the time slot as the block zone. For example, as illustrated in FIG. 9, the time slots [12,16] and [22, 23] within geohash region “66j7bn4” have incident counts of 4 and 2 respectively. Therefore, when the incident threshold is set as two incidents, these combinations of areas and time slots have incident counts no less than the incident threshold. Accordingly, the combination of the time slot [12,16] and the geohash region “66j7bn4” as well as the combination of the time slot [22, 23] and the geohash region “66j7bn4” are designated as another block zone.

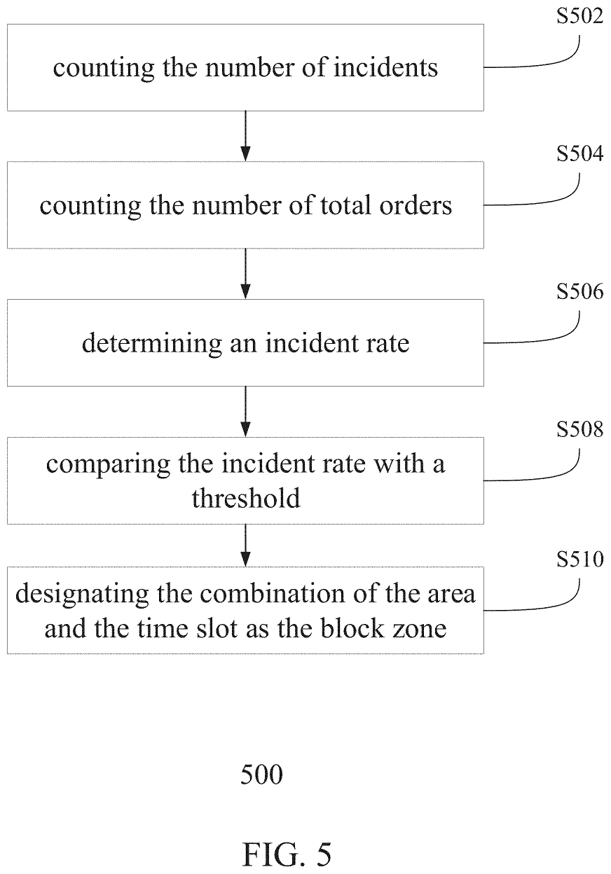

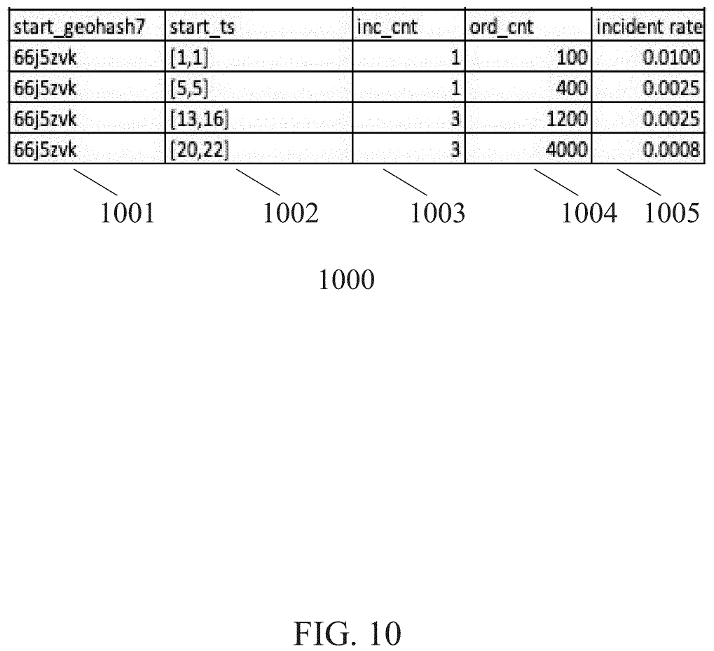

In some other embodiments, the block zone may be determined based on the incident rates in the time slot. FIG. 5 illustrates another flow chart of an exemplary method 500 for designating a block zone, according to embodiments of the disclosure. Method 500 may be implemented by system 101 and may include steps S502-510 as described below. It is to be appreciated that some of the steps may be optional to perform the disclosure provided herein. Further, some of the steps may be performed simultaneously, or in a different order than shown in FIG. 5. FIG. 10 illustrates an exemplary incident rate calculated based on collected incident data, according to embodiments of the disclosure. FIG. 5 and FIG. 10 will be described together.

In some embodiments, in step S502, block zone determination module 105 is further configured to determine the incident count by e.g., count the number of incidents of the area during the time slot, similar to step S402. As illustrated in FIG. 10, from left to right, the first column, column 1001, shows the geohash regions of the incidents, which, in this example, are all within the geohash region “66j5zvk”. The second column, column 1002, lists the time slots within which at least one incident happened. The third column, column 1003, shows the incident count during each time slot within that geohash region.

In step S504, block zone determination module 105 is further configured to determine the order count by e.g., counting the total number of orders made from the respective area during the time slot. For example, the fourth column, column 1004, of FIG. 10 shows the total order count during the time slot within the geohash region. In step S506, the block zone determination module 105 is further configured to determine an incident rate of the area during the time slot as a ratio between the number of incidents and the number of total orders. For example, the fifth column, column 1005, of FIG. 10 shows the incident rate of each time slot within the geohash region. As illustrated in FIG. 10, the incident rate of the area during each time slot in the fifth column 905 is determined by dividing the number of incidents in the third column by the number of total orders in the fourth column.

In step S508, block zone determination module 105 is further configured to compare the incident rate with a rate threshold. The rate threshold can be predetermined as a matter of experience, or can be adjusted according to specific situation of each area. For example, if incidents from an area are mostly serious crimes such as armed robbery causing physical injury of the drivers, the rate threshold in that area should be set lower than an area with most incidents being petty theft.

In step S510, if the incident rate is no less than the rate threshold, block zone determination module 105 is configured to designate the combination of the area and the time slot as the block zone. As illustrated in FIG. 10, the incident rate of the time slot [1,1] is 0.01. Therefore, if the incident rate threshold is set as 0.01, the combination of time slot [1,1] and geohash region “66j5zvk” may be designated as a block zone.

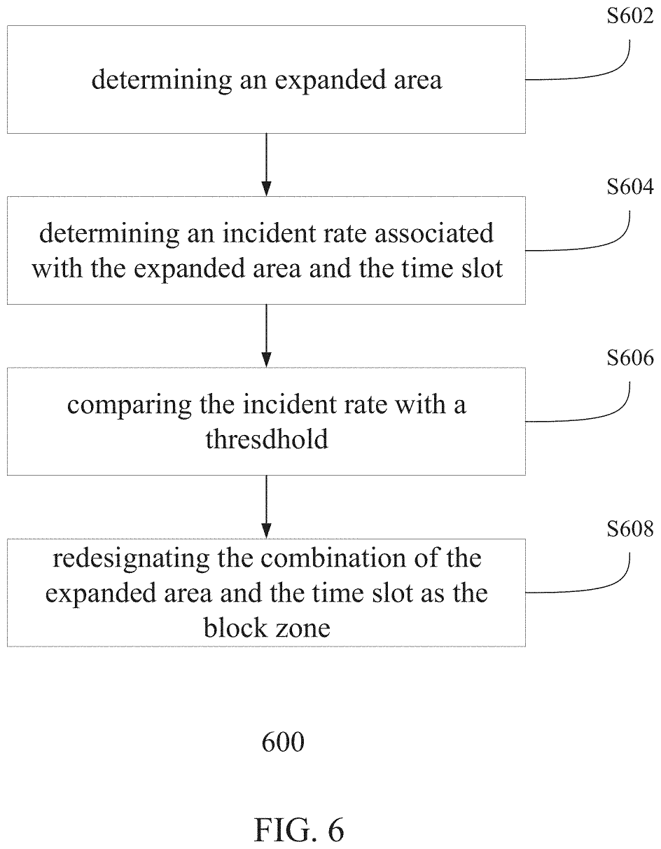

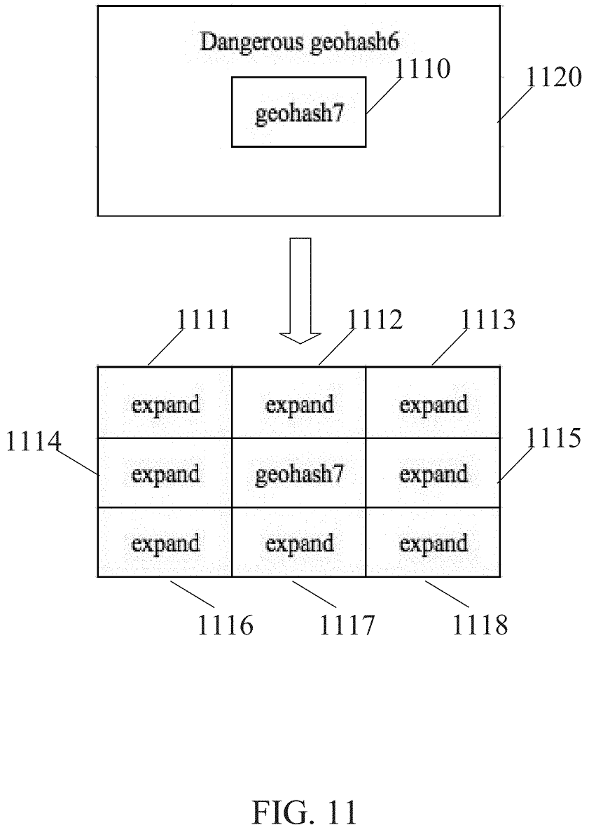

In some other embodiments, the block zone may be geographically expanded from the original geohash region to counter the possibility that the perpetrator gets around the block zone. For example, when an order placed within a block zone is blocked, the perpetrator may move to a nearby region to place the order. Therefore, in some embodiments, the block zone is designed to include those nearby regions when those regions present a moderate risk. FIG. 6 illustrates a flow chart of an exemplary method 600 for designating a block zone with expanded area, according to embodiments of the disclosure. FIG. 11 illustrates a schematic diagram 1100 of an exemplary expanded area, according to embodiments of the disclosure. Method 600 may be implemented by system 101 and may include steps S602-608 as described below. It is to be appreciated that some of the steps may be optional to perform the disclosure provided herein. Further, some of the steps may be performed simultaneously, or in a different order than shown in FIG. 6. FIG. 6 and FIG. 11 will be described together.

In step S602, after block zone determination module 105 is configured to designate a combination of an area and a time slot as a block zone, block zone determination module 105 is further configured to determine an expanded area. The expanded area may expand from the area determined in step S304 to a certain extent. For example, the expanded area may have the same centroid as the original area and expand the radius of the area to form the expanded area. Another example is that the expanded area can be formed by combining the original area with its eight neighboring areas. The neighboring areas may be the same size or different size from the original area. As illustrated in FIG. 11. A geohash region 1110 “geohash7” is determined as the original area of the block zone, then geohash region 1110 is expanded to a geohash6 area 1120 which includes geohash region 1110 and the eight neighboring areas, geohash regions 1111-1118.

In step S604, block zone determination module 105 is configured to determine an incident rate associated with the expanded area and the time slot by dividing the number of incidents in the expanded area by the number of orders in the expanded area. In some embodiments, the incident data of the expanded area can be obtained from database 107 and the incident rate of the expanded are can be calculated the same way as the incident rate of the area of the block zone.

In step S606, block zone determination module 105 is configured to compare the incident rate of the expanded area with an expanded rate threshold. This expanded rate threshold can be the same as or different from the rate threshold used to determine the original area in step S508. The expanded rate threshold can be predetermined as a matter of experience, or can be adjusted according to specific situation of each area.

In step S608, if the incident rate from step S606 is no less than the expanded rate threshold, block zone determination module 105 is configured to redesignate the combination of the expanded area and the time slot as the block zone.

In some embodiments, instead of calculating one incident rate for the entire expanded area, block zone determination module 105 may calculate, in step S604, an incident rate for each neighboring region, e.g., neighboring regions 1111-1118. Then in step S606, block zone determination module 105 may compare the individual incident rates with an expanded rate threshold. The expanded area is filtered based on the comparison. For example, when the incident rate of a neighboring region is no less than the expanded rate threshold, the neighboring region remains in the expanded area. Otherwise, when the incident rate of a neighboring region is less than the expanded rate threshold, the neighboring region is filtered and removed from the expanded area. In step S608, the combination of the filtered expanded area and the time slot is to be redesignated as the block zone.

In some embodiments, incident database 107 may be updated periodically to incorporate new incident data and the block zone may be reassessed and redetermined based on updated incident data periodically. In some embodiments, the incident data update period is shorter than the time range of data used to determine the block zone. For example, the incident data can be updated weekly, and the time range selected to determine the block zone can be the incident data of the three most recent months. Time slots can be combined into larger range or divided into smaller range, according to the data updates.

Returning to FIG. 3, in some embodiments, as part of step 310, the area and its blocked time slot may be flagged or otherwise labeled. In some embodiments, the area and the time slot may be stored in pairs in a list. The list may become a blacklist that can be later used to filter ride-hailing orders.

In step S312, order processing module 106 is configured to block an order generated from the block zone determined in step S310. In some embodiments, passenger device 108 is configured to send a service request order to system 101, and system 101, more specifically order processing module 106, is configured to determine whether the order was sent from the area during the time slot of the block zone determined in step S310. If an order is generated from the area during the time slot of the block zone, order processing module 106 is configured to block the order. If an order is not generated from the area or not during the time slot of the block zone, the order processing module 106 is configured to pass the order for further processing, e.g., to route the service request to a driver with driver device 109.

In some embodiments, an order from a block zone may not be immediately blocked so that a passenger from the block zone can still place an order with additional steps. In some embodiments, the order made from the block zone may be determined as a high-risk order and system 101 may require further authentication steps from the passenger. For instance, system 101 may require the passenger to provide more identification information before the order can be processed and allocated to a driver. For example, system 101 can require the passenger to provide a photo identification (ID) or an ID number. Sometimes the authentication requirement can deter a potential perpetrator from actually committing the crime since his identify is known. It is therefore an effective mechanism to protect drivers from incidents while allowing good-faith passengers to place an order from the block zone.

Another aspect of the disclosure is directed to a non-transitory tangible computer-readable medium storing instructions which, when executed, cause one or more processors to perform the methods, as discussed above. The computer-readable medium may include volatile or non-volatile, magnetic, semiconductor-based, tape-based, optical, removable, non-removable, or other types of computer-readable medium or computer-readable storage devices. For example, the computer-readable medium may be the storage module or the memory module having the computer instructions stored thereon, as disclosed. In some embodiments, the computer-readable medium may be a disc or a flash drive having the computer instructions stored thereon.

It will be apparent to those skilled in the art that various modifications and variations can be made to the disclosed system and related methods. Other embodiments will be apparent to those skilled in the art from consideration of the specification and practice of the disclosed system and related methods.

It is intended that the specification and examples be considered as exemplary only, with a true scope being indicated by the following claims and their equivalents.

1. A method for blocking a ride-hailing order, comprising:
receiving incident data associated with a plurality of incidents, wherein the incident data indicates a time and a location of each incident;
determining, by a processor, an area encompassing the locations of the plurality of incidents;
determining, by the processor, a plurality of time intervals each encompassing the time of at least one incident;
determining, by the processor, a time slot by merging the plurality of time intervals based on a time gap between every two neighboring time intervals;
designating, by the processor, a combination of the area and the time slot as a block zone; and
blocking an order generated from the area during the time slot of the block zone.

2. The method of claim 1, wherein the two neighboring time intervals are merged when the time gap between them is below a time threshold.

3. The method of claim 1, further comprising:
counting the number of incidents of the area during the time slot; and
designating the combination of the area and the time slot as the block zone when the number of incidents exceeds an incident threshold.

4. The method of claim 1, further comprising:
determining an incident rate associated with the area and the time slot;
determining that the incident rate exceeds a rate threshold; and
expanding the area to include its neighboring areas.

5. The method of claim 4, wherein determining the incident rate further comprises:
receiving order data associated with the area;
counting the number of incidents of the area during the time slot;
counting the number of total orders generated from the area during the time slot; and
determining the incident rate as a ratio between the number of incidents and the number of total orders.

6. The method of claim 4, further comprising:
determining an incident rate associated with an expanded area and the time slot exceeds an expanded rate threshold; and
redesignating the combination of the expanded area and the time slot as the block zone.

7. The method of claim 6, further comprising:
determining the incident rate of each combination of each neighboring area in the expanded area and the time slot; and
filtering the expanded area based on the incident rate of each combination.

8. The method of claim 1, further comprising:
receiving updated incident data periodically; and
updating the area and the time slot that is designated as the block zone based on the updated incident data.

9. A system for blocking a ride-hailing order, comprising:
a storage device configured to store incident data associated with a plurality of incidents, wherein the incident data indicates a time and a location of each incident; and
a processor, configured to:
determine an area encompassing the locations of the plurality of incidents;
determine a plurality of time intervals each encompassing the time of at least one incident;
determine a time slot by merging the plurality of time intervals based on a time gap between every two neighboring time intervals;
designate a combination of the area and the time slot as a block zone; and
block an order generated from the area during the time slot of the block zone.

10. The system of claim 9, wherein the two neighboring time intervals are merged when the time gap between them is below a time threshold.

11. The system of claim 9, wherein the processor is further configured to:
count the number of incidents of the area during the time slot; and
designate the combination of the area and the time slot as the block zone when the number of incidents exceeds an incident threshold.

12. The system of claim 9, wherein the processor is further configured to:
determine an incident rate associated with the area and the time slot;
determine that the incident rate exceeds a rate threshold; and
expand the area to include its neighboring areas.

13. The system of claim 12, wherein to determining the incident rate, the processor is further configured to:
receive order data associated with the area;
count the number of incidents of the area during the time slot;
count the number of total orders generated from the area during the time slot; and
determine the incident rate as a ratio between the number of incidents and the number of total orders.

14. The system of claim 12, wherein the processor is further configured to:
determine an incident rate associated with the expanded area and the time slot exceeds an expanded rate threshold; and
redesignate the combination of the expanded area and the time slot as the block zone.

15. The system of claim 14, wherein the processor is further configured to:
determine the incident rate of each combination of each neighboring area in the expanded area and the time slot; and
filter the expanded area based on the incident rate of each combination.

16. The system of claim 9, wherein the processor is configured to:
receive updated incident data periodically; and
update the area and the time slot that is designated as the block zone based on the updated incident data.

17. A non-transitory tangible computer-readable medium storing instructions, wherein the instructions, when executed by a processor, perform a method for blocking a ride-hailing order, the method comprising:
receiving incident data associated with a plurality of incidents, wherein the incident data indicates a time and a location of each incident;
determining an area encompassing the locations of the plurality of incidents;
determining a plurality of time intervals each encompassing the time of at least one incident;
determining a time slot by merging the plurality of time intervals based on a time gap between every two neighboring time intervals;
designating a combination of the area and the time slot as a block zone; and
blocking an order generated from the area during the time slot of the block zone.

18. The computer-readable medium of claim 17, wherein the two neighboring time intervals are merged when the time gap between them is below a time threshold.

19. The computer-readable medium of claim 17, wherein the method further comprises:
counting the number of incidents of the area during the time slot; and
designating the combination of the area and the time slot as the block zone when the number of incidents exceeds an incident threshold.

20. The computer-readable medium of claim 17, wherein the method further comprises:
determining an incident rate associated with the area and the time slot;
determining that the incident rate exceeds a rate threshold; and
expanding the area to include its neighboring areas.
